(19) United States
(12) Patent Application Publication
(10) Pub. No.: US 2011/0187659 A1
(43) Pub. Date: Aug. 4, 2011

(54) DISPLAY APPARATUS

(75) Inventors: In-Youl LEE, Seoul (KR); Min-Su KIM, Goyang-si (KR); Yu-Sik KIM, Cheongju-si (KR); Chang-Hyun KIM, Seoul (KR); Jin-Young SONG, Seoul (KR); Bo-Hwan SHIM, Incheon-si (KR); Jong-Mun YOO, Goyang-si (KR); Young-Tae LEE, Seoul (KR)

(73) Assignee: PANTECH CO., LTD., Seoul (KR)

(21) Appl. No.: 12/987,880

(22) Filed: Jan. 10, 2011

(30) Foreign Application Priority Data
Jan. 29, 2010 (KR) 10-2010-0008811

(51) Int. Cl. G06F 3/041; G09G 5/00

(52) U.S. Cl. 345/173; 345/204

(57) ABSTRACT

A display apparatus displays a images depending on a viewing angle. The display includes a panel unit including a plurality of unit pixels, each unit pixel including a plurality of sub-pixels having different polarization characteristics, and a control unit to control the sub-pixels, the sub-pixels respectively displaying at least one image polarized at different angles. The display apparatus may display different images simultaneously through a screen.

### CROSS-REFERENCE TO RELATED APPLICATION

This application claims priority from and the benefit under 35 U.S.C. §119(a) of Korean Patent Application No. 10-2010-0008811, filed on Jan. 29, 2010, the disclosure of which is incorporated herein by reference in its entirety for all purposes.

### BACKGROUND

1. Field

The following description relates to a display apparatus, and more particularly, to a display apparatus capable of displaying a different image depending on viewing angle.

2. Discussion of the Background

In a conventional display apparatus using a parallax barrier, the parallax barrier is disposed at a predetermined distance away from a rear side of a display panel of a liquid crystal is display (LCD). Such a display apparatus displays different images via sets of pixels of the LCD corresponding to a viewing angle. Accordingly, if a user changes position and changes viewing angles with respect to the LCD, the image viewed by the user also changes.

However, such a display apparatus may produce crosstalk between respective viewing angles, thereby decreasing the image quality. In addition, since a large amount of light is blocked by the parallax barrier, the brightness of the display may be decreased.

### SUMMARY

Exemplary embodiments of the present invention provide a display apparatus capable of simultaneously displaying different images through a screen.

Exemplary embodiments of the present invention provide a multi-tasking display apparatus capable of simultaneously performing a plurality of operations without a complicated mode conversion.

Exemplary embodiments of the present invention provide a display apparatus that may have a uniform resolution, decreased interference due to light scattered between sub-pixels.

Additional features of the invention will be set forth in the description which follows, and in part will be apparent from the description, or may be learned by practice of the invention.

An exemplary embodiment provides a display apparatus including a panel unit comprising a plurality of unit pixels, each unit pixel comprising a plurality of sub-pixels having different polarization characteristics, and a control unit to control the sub-pixels, the sub-pixels respectively displaying at least one image polarized at different angles.

An exemplary embodiment provides a display apparatus including a panel unit is comprising a plurality of unit pixels, each unit pixel comprising a square frustum shape or a square pyramid shape.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram of a display apparatus according to an exemplary embodiment.

FIG. 2 is a plan view of a unit pixel of a panel unit according to an exemplary embodiment.

FIG. 3 is a cross sectional view of a unit pixel of a panel unit according to an exemplary embodiment.

FIG. 4 is a view of a unit pixel having a three-dimensional layer structure according to an exemplary embodiment.

FIG. 5 is a view showing an operation of a display apparatus according to an exemplary embodiment.

FIG. 6 is a view showing an operation of a display apparatus according to an exemplary embodiment.

FIG. 7 is a view showing an operation of a display apparatus according to an exemplary embodiment.

FIG. 8 is a view showing an operation of a display apparatus according to an exemplary embodiment.

FIG. 9 is a view showing an operation of a display apparatus according to an exemplary embodiment.

FIG. 10 is a view showing an operation of a display apparatus according to an exemplary embodiment.

FIG. 11 is a view showing an operation of a display apparatus according to an exemplary embodiment.

FIG. 12 is a view showing an operation of a display apparatus according to an exemplary embodiment.

### DETAILED DESCRIPTION

The invention is described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

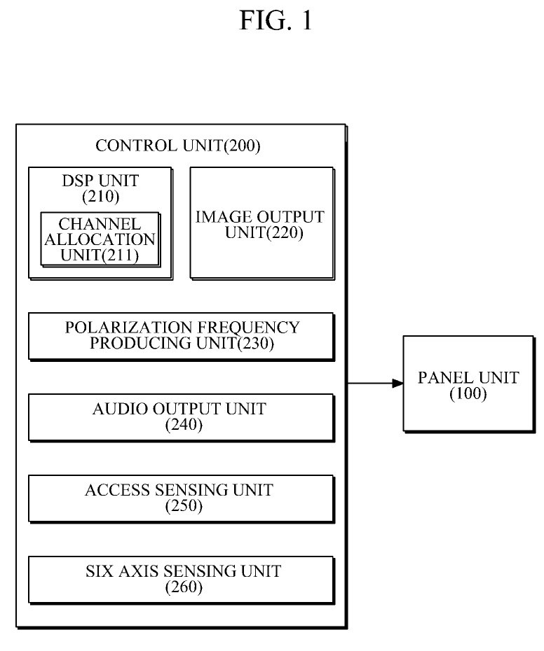

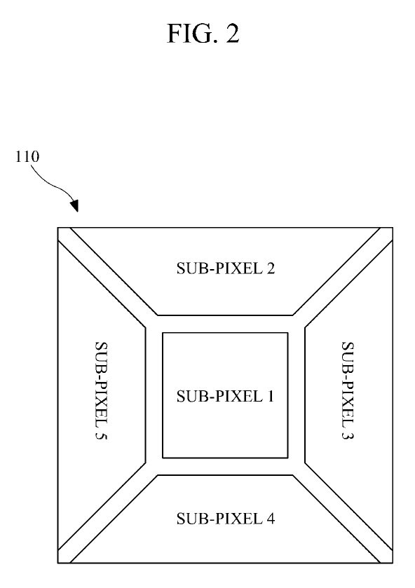

FIG. 1 is a block diagram of a display apparatus according to an exemplary embodiment. As shown in FIG. 1, a display apparatus includes a panel unit 100 and a control is unit 200. The display apparatus 100 may be described as a multi-dividing display apparatus. The panel unit 100 displays different images by a plurality of pixels depending on a viewing angle. The panel unit 100 includes a plurality of unit-pixels 110, for example, as shown in FIG. 2, each including a plurality of sub-pixels, each sub-pixel having different polarization characteristics. The unit-pixels 110 are combined together to form the panel unit 100.

The control unit 200 performs control operations such that different images are simultaneously displayed on the panel unit 100 by controlling the angle of deviation of each sub-pixel in a physical or electrical manner. For example, as the control unit 200 performs control operations, different images are simultaneously displayed on the panel unit 100 including the unit-pixels 110. Hereinafter, the unit pixel 110 of the panel unit 100 and the control unit 120 will be described in detail.

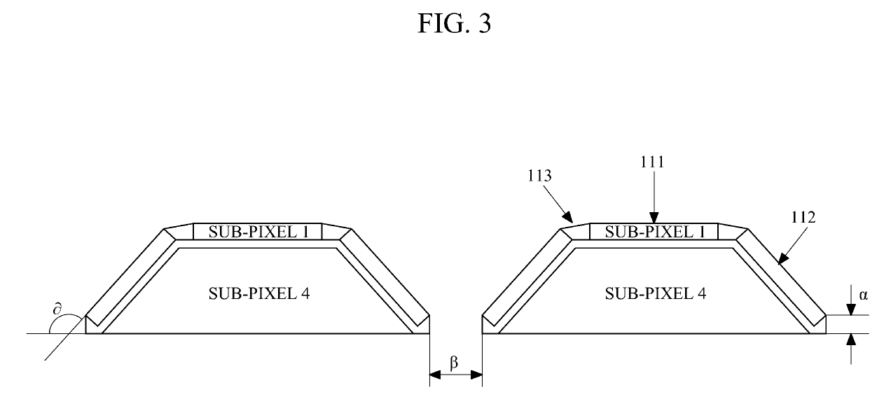

FIG. 2 is a plan view of a unit pixel of a panel unit according to an exemplary embodiment, and FIG. 3 is a cross sectional view of a unit pixel of a panel unit according to an exemplary embodiment.

As shown in FIG. 2 and FIG. 3, the unit-pixel 110 of the panel unit 100 includes sub-pixels 1, 2, 3, 4, and 5 in which the sub-pixel 1 is disposed in a center of the unit pixel 110 and the sub-pixels 2, 3, 4, and 5 surround the sub-pixel 1. For example, the sub-pixel 1 is a center sub-pixel 111 disposed in the center of the unit pixel 110, and the sub-pixels 2, 3, 4, and 5 are adjacent sub-pixels 112 that are each provided in the form of a trapezoid and are disposed adjacent to the four sides of the square shaped center unit pixel 110, i.e., the unit pixel 110 may be a pyramidal frustum. For example, if the unit pixel 110 is a square, pyramidal frustum, the adjacent sub-pixels 112 may each extend from the four sides of the center sub-pixel 111 at an internal angle of about 120 to 140 degrees.

However, aspects of the present invention are not limited thereto. According to exemplary embodiments, the unit pixel 110 may include more or fewer sub-pixels, for example, the unit pixel 110 may include sub-pixels 1′, 2′, 3′, and 4′, and the sub-pixels 1′, 2′, 3′, and 4′ may be disposed in the shape of a quadrangular pyramid to form the unit-pixel 110. Further, the center sub-pixel 111 need not be square but may be circular, elliptical, or polygonal.

Further, according to exemplary embodiments of the present invention, the unit pixels 110 may further include guide blocks 113. The guide block 113 is formed of a crosstalk blocking film which prevents interference due to light scattered between the center sub-pixel 111 and the adjacent sub-pixel 112 or between the adjacent sub-pixels 112. Meanwhile, in order to display different images, an angle formed between the sub-pixels 112 of the display is determined with respect to a substrate. An angle ∂ with respect to the substrate of the display apparatus is determined. In this case, the angle formed by the adjacent sub-pixels 112 may vary depending on the angle ∂, which affects the resolution of the image displayed on the panel unit 100. For example, the angle ∂ may be between about 120 to 140 degrees. Further, if the unit pixel 110 is a square pyramid, the angle ∂ may be between about 120 to 140 degrees. In addition, each of the height α of the guide block 113 and the distance β between the unit pixels 110 of the display apparatus may be determined, and unit pixels 110 may be form based on the values ∂, α, and β.

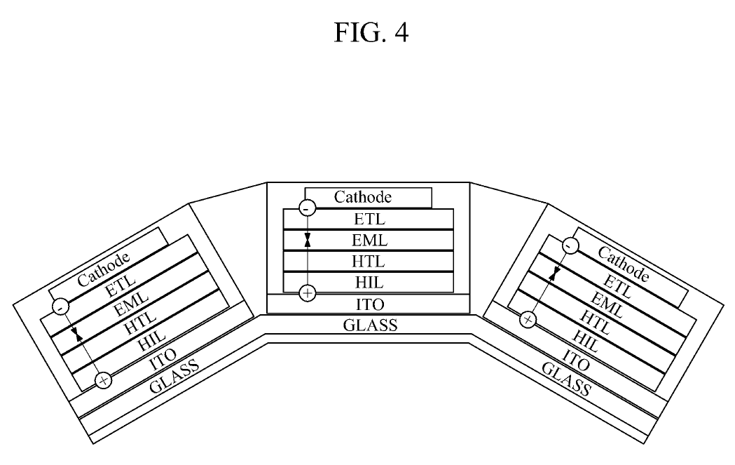

FIG. 4 is a view of a unit pixel having a three-dimensional layer structure according to an exemplary embodiment. As shown in FIG. 4, the unit pixel 110 may be manufactured through a same or similar manufacturing process as a Passive Matrix Organic Light Emitting Diode (PMOLED) or as an Active Matrix Organic Light Emitting Diode (AMOLED). All processes of forming such a three-dimensional (3-D) layer structure are is performed on frame layer for a 3-D structure. Meanwhile, each of the sub-pixels 1, 2, 3, 4, and 5 has a structure including a glass substrate formed of glass, an anode formed of indium tin oxide (ITO), a hole injection layer (HIL), a hole transfer layer (HTL), an emission material layer (EML), an electron transfer layer (ETL), and a cathode that are formed on top of each other, in which the HIL, HTL, EML, and ETL are formed of organic materials. However, aspects are not limited thereto such that additional layers may be included or layers may be excluded. For example, a hole blocking layer (HBL) and/or an electron blocking layer (EBL) may be included.

The glass substrate is formed to correspond to the 3-D structure of the frame layer. The anode is connected to a voltage source and allows electrical current to pass through the organic layers to cause light emission or electroluminescence of the EML. If the anode has a positive electrical potential higher than that of the cathode, the anode injects holes into the organic layers. The HIL enhances the injection efficiency of holes injected from the anode to the HTL, the HTL serves to transfer holes to the EML, and the EML emits light which is generated by the recombination of holes and electrons in the EML. The ETL transfers electrons injected from the cathode to the EML. The cathode is a thin film formed of conventional conducing material and may be a totally reflective material, and includes an alloy allowing electrons to be effectively transferred to the ETL. Similar to the anode, the cathode is connected to a voltage source and allows electrical current to pass through the organic layers to cause light emission or electroluminescence of the EML. However, aspects are not limited thereto such that either or both of the anode and the cathode may be transparent or reflective.

Referring again to FIG. 1, the control unit 200 performs control operations such that different images are simultaneously displayed in different directions. Referring again to FIG. 1, the control unit 122 includes a digital signal processing (DSP) unit 210, an image output is unit 220, and a polarization frequency producing unit 230. The DSP unit 210 converts the images to be displayed on the sub-pixels 1, 2, 3, 4, and 5, respectively, into digital signals and performs a data packaging on the images such that different images are displayed in different directions from the panel unit 100. The image output unit 220 reconstructs the images, which have been converted into digital signals, to be suitable for the respective sub-pixels, and transmits the reconstructed images to the respective sub-pixels 1, 2, 3, 4, and 5. A plurality of image output units 220 may be included to correspond one-to-one to the number of the sub-pixels 1, 2, 3, 4, and 5.

The DSP unit 210 includes a channel allocation unit 211. The channel allocation unit 211 allocates channels to the image output unit 220 such that the different images, which have been converted into digital signals, are transmitted to the image output unit 220. The channel allocation unit 211 may respectively allocate channels to plural image output units 220, and, if the channel allocation unit 211 respectively allocates channels to the respective image output units 220, the DSP unit 210 transmits the images, which have been converted into digital signals, to the respective channels.

The image output unit 220 receives an image transmitted from the DSP unit 210 through a predetermined channel related to the image output unit 220, reconstructs the received image and transmits the reconstructed image to the sub-pixels 1, 2, 3, 4, and 5. The polarization frequency producing unit 230 produces electrical frequencies to adjust polarization characteristics for each of the sub-pixels 1, 2, 3, 4, and 5. In this manner, the polarization frequency producing unit 230 adjusts polarization characteristics of the sub-pixels 1, 2, 3, 4, and 5, and the sub-pixels 1, 2, 3, 4, and 5 display images transferred from their image output unit 220. As a result, the panel unit 100 may allow different images or the same image to be viewed is from the front/rear/left/right/center sides of the panel unit 100 via the sub-pixels 1, 2, 3, 4, and 5.

Meanwhile, the control unit 200 may further include an audio output unit 240. The audio output unit 240 outputs audio sound corresponding to each of the different images that are displayed on the sub-pixels 1, 2, 3, 4, and 5, respectively, through speakers or audio outputs corresponding to each of the sub-pixels 1, 2, 3, 4, and 5. The speaker may be implemented as a hypersonic speaker. The hypersonic speaker is an ultrasonic directional speaker which, for example, achieves an improved directivity efficiency of 99% and operates regardless of medium of propagation.

The control unit 200 may further include an access sensing unit 250 and a six axis unit 260. The access sensing unit 250 controls images displayed on the sub-pixels 1, 2, 3, 4, and 5 in a manner to sense a touch of a user positioned adjacent to a predetermined sub-pixel and control an image displayed on the predetermined sub-pixel. The six-axis sensor unit 260 changes a display direction of the images such that an image currently displayed on a predetermined sub-pixel is moved to be displayed on a sub-pixel adjacent to the predetermined sub-pixel according to a motion of the display apparatus.

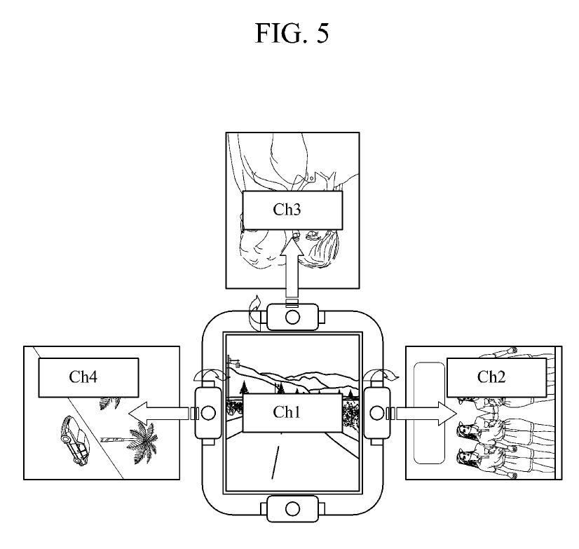

Hereinafter, an operation of the display apparatus will be described with reference to FIGS. 5 to 12 in detail.

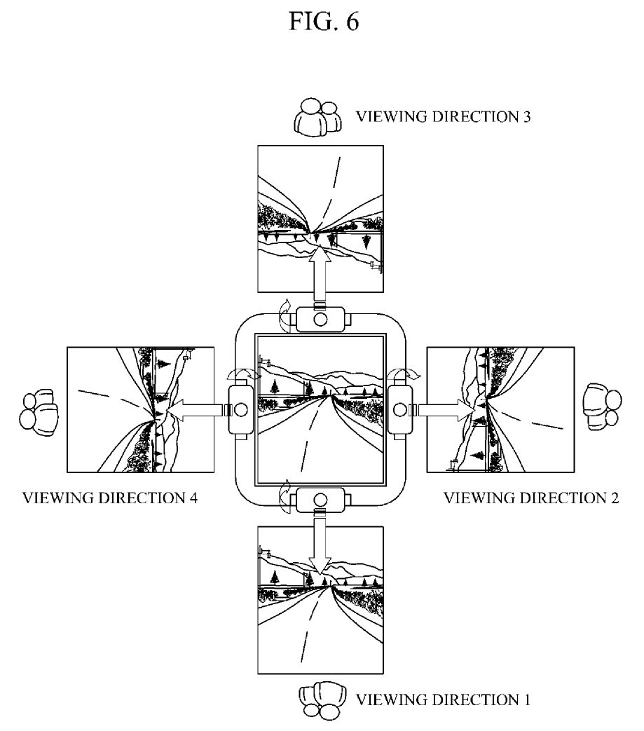

FIG. 5 is a view showing an operation of a display apparatus according to an exemplary embodiment, and FIG. 6 is a view showing an operation of a display apparatus according to an exemplary embodiment.

As shown in FIG. 5 and FIG. 6, the display apparatus outputs sound for moving images that are displayed in different directions.

For example, a mobile communication terminal displays on the panel unit 100 is including, for example, the sub-pixels 1, 2, 3, 4, and 5, depending on a viewing direction such that different images or the same image may be viewed from the front/rear/left/right side of the mobile communication terminal. As shown in FIG. 5, the display apparatus displays different images through channels 1, 2, 3, and 4 among channels 1, 2, 3, 4, and 5. The hypersonic speakers, which are disposed adjacent to the respective four sides of a screen, output sound in the same direction as the display direction for each of the moving images displayed through their respective channels.

That is, the hypersonic speakers corresponding to each of the channels 2, 3, and 4 output sound related to the channels 2, 3, and 4 in the display directions of the respective channels 2, 3, and 4, and the remaining hypersonic speaker outputs sound related to the channel 1 in an upper direction.

Meanwhile, as shown In FIG. 6, if the display apparatus displays the same moving image on the channels 1, 2, 3, 4, and 5, the display apparatus outputs sound in the same direction as the display direction of each of the moving images displayed through respective channels 2, 3, 4, and 5. For example, when four users are positioned in viewing directions 1, 2, 3, and 4 of a mobile communication terminal, a reproduced image of the mobile communication terminal may be rotated according to the respective viewing directions 1, 2, 3, and 4 of the user such that all users watch the same image regardless of their positions.

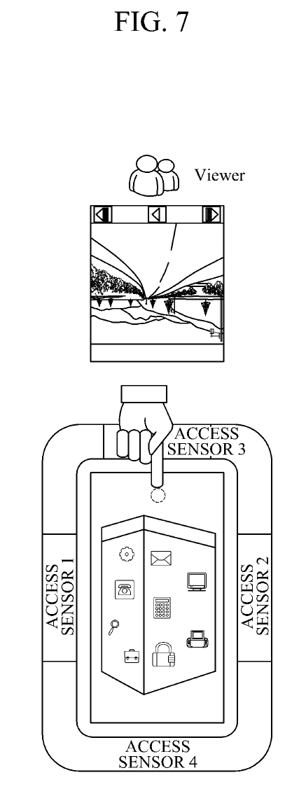

FIG. 7 is a view showing an operation of a display apparatus according to an exemplary embodiment. As shown in FIG. 7, the display apparatus controls each of the images that are individually displayed on a single screen. That is, the display apparatus includes a plurality of unit pixels 110, each including a touch window and a plurality of sub-pixels 1, 2, 3, 4, and 5. Access sensors 1, 2, 3, and 4 may be disposed about the panel unit 100, for example, in is the front/rear/left/right sides of the panel unit 100. For example, when a mobile communication terminal displays a moving image through at least one of channels 1, 2, 3, 4, and 5, if a user watching the corresponding moving image touches an area corresponding to the access sensor 3, the mobile communication terminal displays buttons on the moving image, which are used to control the corresponding moving image, and the user controls playback of the corresponding moving image by manipulating the buttons. For example, the user may stop, start, replay, etc., the corresponding moving image through the buttons displayed on the moving image. Further, playback may stop or pause upon touching at least one of the areas corresponding to the access sensors.

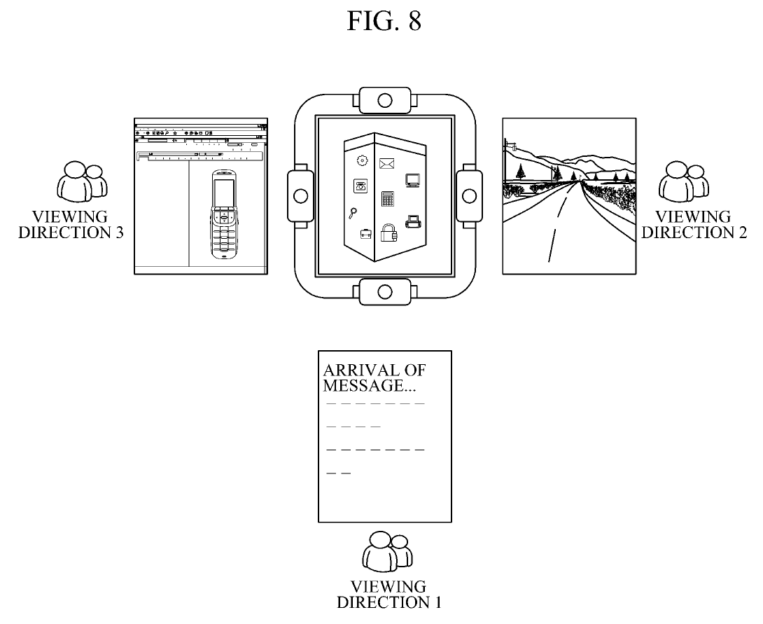

FIG. 8 is a view showing an operation of a display apparatus according to an exemplary embodiment. As shown in FIG. 8, the display apparatus may execute different applications for each of the sub-pixels 1, 2, 3, 4, and 5, thereby implementing multi-tasking on a single screen. For example, the mobile communication terminal may execute different applications involving the internet, a game, a moving image, and a short message service (SMS), and the like, such that a website, a game, a moving image, and a short message service are displayed to the various viewing directions. In addition, a menu-related application may be executed on the center of the screen to display a menu. In this manner, a user positioned in the front side of the mobile communication terminal may browse online, a user positioned to the rear side of the mobile communication terminal may play a game, a user positioned to the left side of the mobile communication terminal may watch a moving image, and a user positioned to the right side of the mobile communication terminal may send a message.

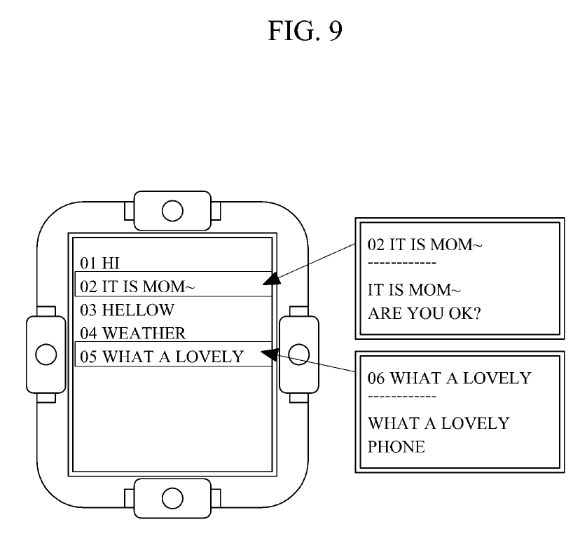

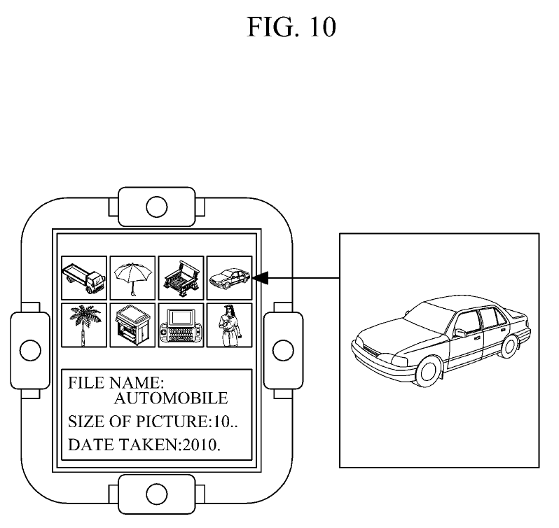

FIG. 9 is a view showing an operation of a display apparatus according to an exemplary embodiment, and FIG. 10 is a view showing an operation of a display apparatus is according to an exemplary embodiment.

As shown in FIG. 9, the display apparatus may display text or information other than still and moving images. For example, the display apparatus may display a text list storing some portions of texts or titles of texts together with the entire content of a text selected from the text list such that the user checks a text list and the entire content of a text selected from the text list in real time or simultaneously, for example, at a different viewing direction. As a further example, the mobile communication terminal may display a moving image separately from subscripts related to the moving image on a single screen, for example, according to viewing direction, thereby facilitating watching the moving image and subscripts. As another example, as shown in FIG. 10, the display apparatus may display a photograph list storing photographs together with a photograph selected from the photograph list such that the user may view the photograph list and the selected photograph in real time or simultaneously, according to viewing direction.

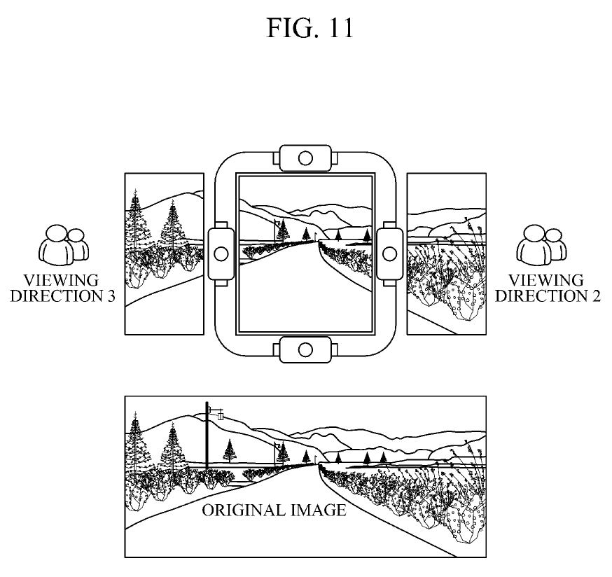

FIG. 11 is a view showing an operation of a display apparatus according to an exemplary embodiment. As shown in FIG. 11, the display apparatus displays the entirety of an image, such as a wide view image. The display apparatus may divide an image into three images and processes the three images such that the images are individually displayed in three areas. For example, the display apparatus displays a center image, a left-side image, and a right-side image in the center, left, and right portions of a screen, respectively, e.g., according to viewing directions 2 and 3, thereby displaying the entirety of the image on a single screen.

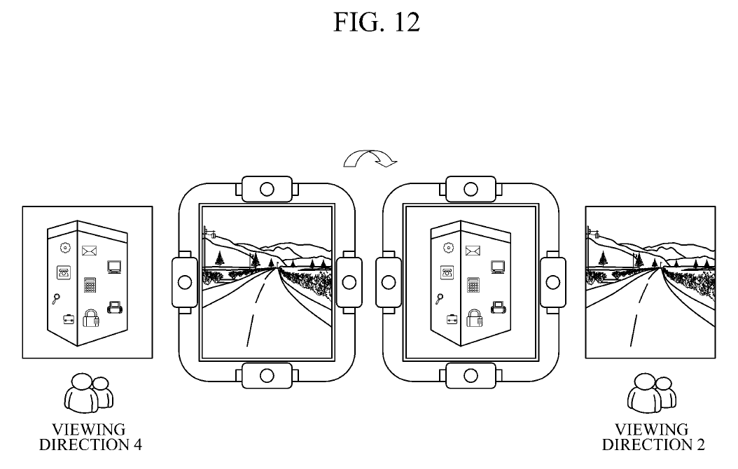

FIG. 12 is a view showing an operation of a display apparatus according to an exemplary embodiment. As shown in FIG. 12, the display apparatus may shift playback scenes on the respective sub-pixels 1, 2, 3, 4, and 5 depending on a recognition direction by use of a six-axis sensor, that is, a direction sensor. As an example, when a menu image is displayed on the left side of a screen, i.e., the menu image is displayed to viewing direction 4, and a picture image is displayed on the center of the screen in a display apparatus, if a user applies an action to the right side of the screen, the display apparatus allows the menu image to be displayed on the center of the screen and allows the picture image to be displayed on the right side of the screen, i.e., the picture image is displayed to the viewing direction 2, as shown in FIG. 12. As another example, when a menu image, a picture image or a web-browser is displayed on the left side of a screen, a moving picture is displayed on the center of the screen and audio sound related to the moving picture is output through a hypersonic speaker corresponding to the center of the screen in a display apparatus, if a user applies an action to the right side of the screen, the menu image, the picture image, or the web-browser is displayed on the center of the screen and the moving picture is displayed on the right side of the screen. In this case, the display apparatus performs controls to operate a hypersonic speaker corresponding to the right side of the screen such that sound corresponding to the moving picture, which has been shifted to be displayed on the right side of the screen, is output from the right side of the screen. As a result, an image displayed on the right side of the screen is changed into the moving picture and sound related to the moving picture is output through the hypersonic speaker corresponding to the right side of the display apparatus.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A display apparatus, comprising:
a panel unit comprising a plurality of unit pixels, each unit pixel comprising a plurality of sub-pixels having different polarization characteristics; and
a control unit to control the sub-pixels, the sub-pixels respectively displaying at least one image polarized at different angles.

2. The display apparatus of claim 1, wherein the unit pixel comprises a center sub-pixel disposed in the center of the unit pixel and a plurality of sub-pixels disposed about the center sub-pixel.

3. The display apparatus of claim 2, wherein the center sub-pixel is square; and
the plurality of sub-pixels disposed about the center sub-pixel are trapezoidal, and each of the plurality of sub-pixels extends from a respective side of the center sub-pixel at an internal angle of 120 to 140 degrees with respect to the center sub-pixel.

4. The display apparatus of claim 2, wherein the unit pixel comprises a guide block comprising a crosstalk blocking film to prevent interference due to light scattered between adjacent sub-pixels.

5. The display apparatus of claim 1, wherein the control unit comprises:
a digital signal processing unit to convert the different images that are to be displayed from each of the sub-pixels into respective digital signals;
a plurality of image output units corresponding to the respective sub-pixels to reconstruct the different images, which have been converted into the respective digital signals, to be suitable for the respective sub-pixels and to output the reconstructed different images to the respective sub-pixels; and
a polarization frequency producing unit to produce an electrical frequency to adjust the polarization characteristics for each respective sub-pixel.

6. The display apparatus of claim 5, wherein the digital signal processing unit comprises:
a channel allocation unit to allocate channels to the image output units such that the different images, which have been converted into digital signals, are transmitted to the image output units respectively.

7. The display apparatus of claim 5, wherein the control unit comprises an audio output unit to output audio sound corresponding to each of the different images.

8. The display apparatus of claim 5, wherein the control unit comprises:
an access sensing unit to sense a touch of a user to control operation on the image displayed on at least one of the plurality of sub-pixels.

9. The display apparatus of claim 5, wherein the control unit comprises:
a six-axis sensing unit to change a display direction of the images such that an image displayed on at least one of the plurality of sub-pixels is displayed on another one of the plurality of sub-pixels.

10. The display apparatus of claim 1, wherein the unit pixel comprises a square frustum shape or a square pyramid shape,
wherein the sub-pixels are disposed on at least one side of the square frustum shape or the square pyramid shape.

11. The display apparatus of claim 10, wherein an internal angle between a top of the square frustum shape and a side of the square frustum shape is between about 120 to 140 degrees.

12. The display apparatus of claim 10, wherein an internal angle between a base of the square pyramid shape and a side of the square pyramid shape is between about 40 to 60 degrees.

13. The display apparatus of claim 10, wherein images are displayed on internal surfaces of the square frustum shape or the square pyramid shape.

14. The display apparatus of claim 1, wherein the control unit controls the unit pixels to display at least an image in different directions according to a viewing angle of the display apparatus.

15. The display apparatus of claim 14, wherein the at least an image comprises at least one of a still image, a video image, and an application.

16. The display apparatus of claim 1, wherein the control unit controls the unit pixels to display a first portion of a first image in a first direction according to a viewing angle of the display apparatus and a second portion of the first image in a second direction according to a viewing angle of the display apparatus.

17. The display apparatus of claim 1, wherein the control unit controls the unit pixels to display different images in different directions according to a viewing angle of the display apparatus.

18. A display apparatus, comprising:
a panel unit comprising a plurality of unit pixels, each unit pixel comprising a square frustum shape or a square pyramid shape.

19. The display apparatus of claim 17, wherein each unit pixel comprises a sub-pixel disposed on at least one surface of the square frustum shape or the square pyramid shape.

20. The display apparatus of claim 17, further comprising:
a control unit to control a first sub-pixel of one of the unit pixels to display at least one image polarized at a first angle and a second sub-pixel of the one of the unit pixels to display the at least one image polarized at a second angle different from the first angle.
